(19) United States
(12) Patent Application Publication
(10) Pub. No.: US 2025/0086149 A1
(43) Pub. Date: Mar. 13, 2025

(54) System for increasing quantity and quality of data in machine learning

(71) Applicant: William Easttom, II, Plano, TX (US)

(72) Inventor: William Easttom, II, Plano, TX (US)

(21) Appl. No.: 18/347,251

(22) Filed: Jul. 5, 2023

(51) Int. Cl. G06F 16/215; G06F 16/951

(52) U.S. Cl. CPC G06F 16/215; G06F 16/951

(57) ABSTRACT

A system and method for improving data quality and content for machine learning. Machine learning depends on training data. The system is for acquiring new data, as well as for checking data for data quality. Data acquisition can include web crawling, OCR of data, and similar modalities. Data quality can be checked by statistical algorithms, information theory algorithms, and related methodologies. The system is able to seek out new data on its own, then assess the quality of said data.

### FIELD OF INVENTION

The present invention relates to machine learning, and more particularly, the present invention relates to data processing in machine learning.

### BACKGROUND OF THE INVENTION

Machine learning is a field that has substantial potential but also substantial challenges. Two challenges that affect all machine learning projects are 1) getting enough and appropriate data for training; 2) offloading the workload so that the primary computer is not overburdened with the process. The current invention addresses both of these issues. Furthermore, the current invention provides a novel method for determining the fitness of new data before adding it to the training set. Data quality is a substantial issue in machine learning and data mining. Addressing this issue is critical for improving machine learning.

US patent 20190392001A1 (“Carothers”) is based on fusing data for artificial intelligence. This particular invention works on the reception of data and filtering data. While this invention addresses some issues in the machine learning domain, it does not address specific issues that are addressed by the current invention. First, Carothers has no mechanism for seeking out new data. Secondly, Carothers has no means of segregating the workload other than using conventional GPU's. Further, Carothers has no mechanism for determining the fitness of new data.

U.S. Pat. No. 10,922,625B2 (“Ma”) addressed the issue of workload distribution. This invention seeks to offload some subset of processing to an external computing service. However, Ma does not address improvements to data quantity and quality. Furthermore, Ma uses a different approach to distributed workload.

U.S. Pat. No. 10,089,581B2 (“Flores”) assigned to Boeing, checks to see if data quality meets or exceeds a given threshold. This invention does not specify any particular methods for assessing data quality. Claim 4 simply indicates a star rating system. Nor does this invention disclose any mechanism for gathering additional data. Claim 3 simply states data is obtained from some database.

U.S. Ser. No. 10/679,100B2 (Kang), assigned to Cline inc. The abstract of this invention states “Systems and methods of intelligent formation and acquisition of machine learning training data for implementing an artificially intelligent dialogue system includes constructing a corpora of machine learning test corpus that comprise a plurality of historical queries and commands sampled from production logs of a deployed dialogue system; configuring training data sourcing parameters to source a corpora of raw machine learning training data from remote sources of machine learning training data; calculating efficacy metrics of the corpora of raw machine learning training data, wherein calculating the efficacy metrics includes calculating one or more of a coverage metric value and a diversity metric value of the corpora of raw machine learning training data; using the corpora of raw machine learning training data to train the at least one machine learning classifier if the calculated coverage metric value of the corpora of machine learning training data satisfies a minimum coverage metric threshold.”

However, Kang depends on historical data (claim 1). Furthermore, Kang merely describes a ‘coverage metric’ without disclosing data quality metrics. The coverage metric is well described in claims 5 and 7 and is clearly quite different than the data quality metrics of the current invention. Furthermore, Kang does not disclose how new data can be acquired. Furthermore, Kang is focused specifically and narrowly on medical data.

U.S. Pat. No. 11,185,292B2 (Capodilupo) assigned to Whoop inc. This patent is directed towards data quality from a physiological monitoring device. Data is only ingested from physiological monitors such as a heart monitor. The quality of data is determined by a specific metric assigned to, for example, heart rate. The approach to data quality in Capodilupo is much less robust, and a different methodology than in the current invention.

U.S. Pat. No. 11,556,280B2 (Gold) to Pure Storage Inc. The Gold patent is directed towards applying transformations to data in order to provide data in a specified format. It has no disclosure of querying data, OCR data, or checking data quality.

US20190378051AI (Douglas) assignee Bank of America. The Douglas patent is directed towards utilizing graph theory in a graph module as part of the decision making process. It has no disclosure of querying data, OCR data, or checking data quality.

AU2019253860B2 (Gould) assigned to Ab Initio Technology LLC is directed towards analyzing an existing dataset compared to a reference profile to determine data quality. While this is related to data quality, it uses an entirely different approach than the current invention. It has no disclosure of querying data or OCR data.

U.S. Pat. No. 11,436,428B2 (Trenholm) Assigned to Sightline Innovation. This patent is directed towards increasing data quality specifically for semi-supervised machine learning. Each data point has a predetermined threshold that must be met. It has no disclosure of querying data, OCR data, and its data quality mechanism is both more primitive than the current invention, and it takes an entirely different approach.

### BRIEF DESCRIPTION OF THE DRAWINGS

FIG. 1 shows an overview of the process of the current invention. Step 101 assess the current data to determine if more data is needed. If more data is needed, then the system proceeds to step 103 and acquires more data. If enough data is present, the system proceeds with data quality assessment using data quality metrics. Metrics could include the diversity of data available, the information content of the data available, or other relevant metrics.

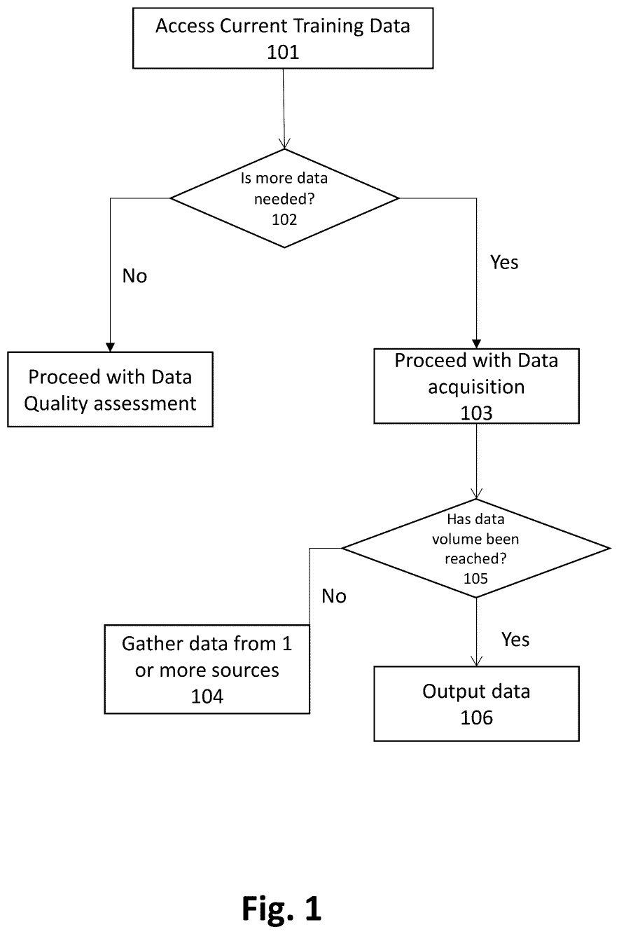

FIG. 2 shows the general process for data quality verification. Data is ingested in step 201. This step involves taking currently available data and reading it into the module responsible for assessing current data (step 201 of FIG. 2). Step 202 checks the data quality according to some threshold. The data quality metric can be diversity of data, information entropy of the data, or other metric chosen in a particular implementation of this current invention. The algorithms used could be any algorithm that assesses information. A sampling of such algorithms is provided in the next section. After step 202, if it is determined that the input data is not yet ready for use in training an algorithm, then that data is shunted to 203 for the purpose of further analysis. If the data is determined to meet minimum data quality metrics in step 202, then it is forwarded to step 204.

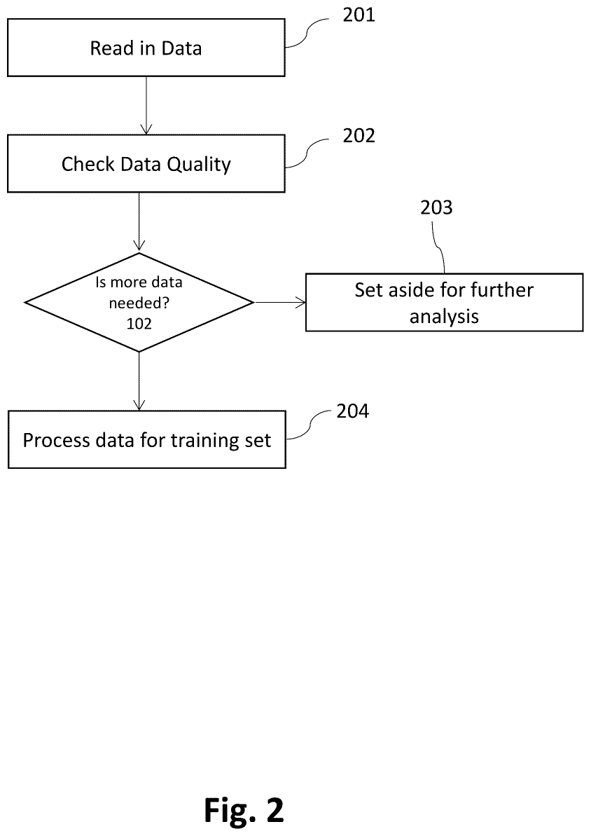

FIG. 3 shows a close up of step 202 from FIG. 2. The algorithms listed are exemplary and not exhaustive. In FIG. 3 one or more data quality algorithms are used in order to evaluate incoming data to determine if it meets a particular data quality threshold.

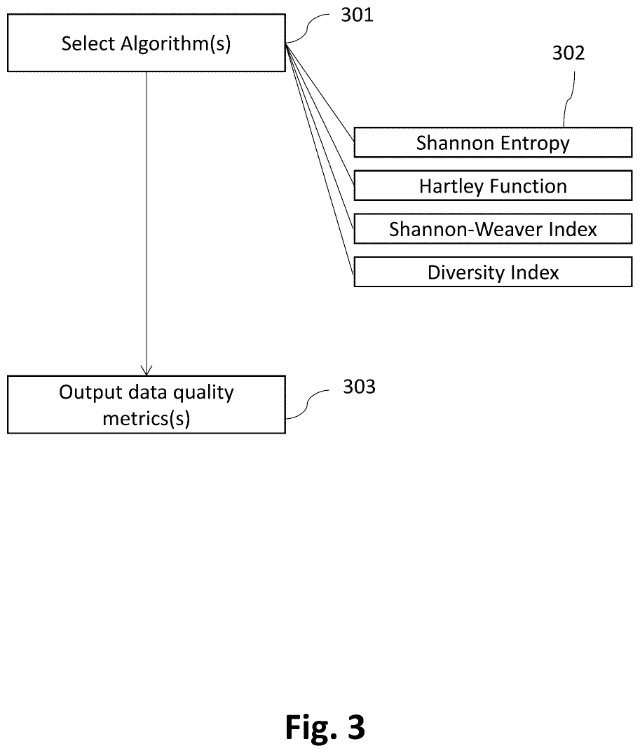

FIG. 4 shows a dual core processor. In one embodiment of the current invention, the separate modules of the current invention are implemented and executed on different cores of a multi-core processor. While the figure shows 2 cores, one of ordinary skill in the art would understand the current system could be implemented on any number of cores.

FIG. 5 shows another embodiment of the current invention which is implemented on multi-processor system. Rather than separate cores, the modules of the current system are implemented on separate processors.

FIG. 6 shows one example of an algorithm for web crawling that can be used in some embodiments of the current invention.

FIG. 7 shows the general process of web crawling.

FIG. 8 shows an exemplary source code for web scraping.

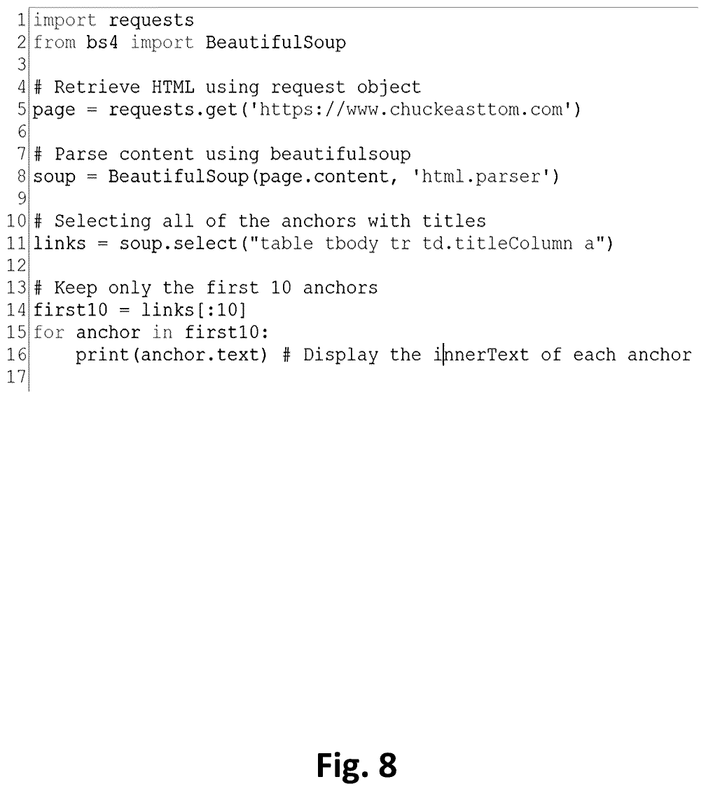

FIG. 9 shows an additional example of web scraping.

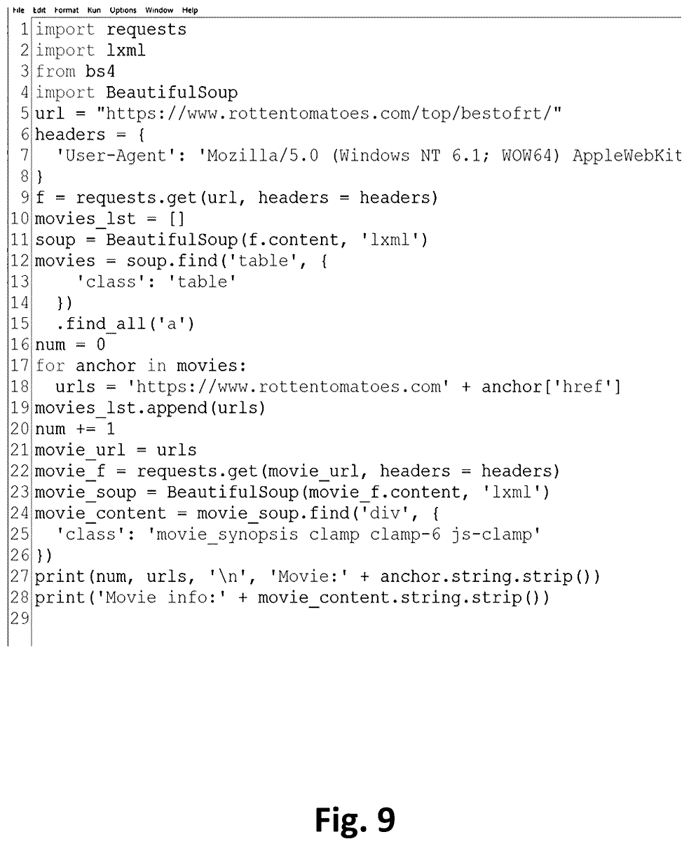

### DESCRIPTION OF THE INVENTION

The current invention describes a system for facilitating machine learning systems to query for new data, then evaluate the quality of said data prior to incorporating that data into the machine learning training data set. This facilitates machine learning algorithms being enabled to augment their own training data while maintaining data quality.

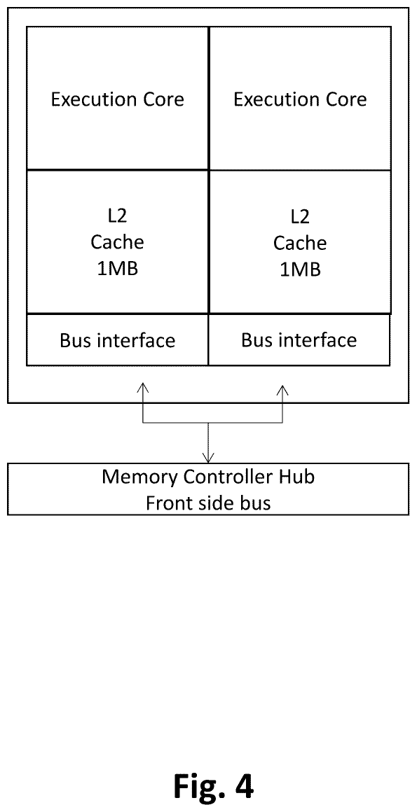

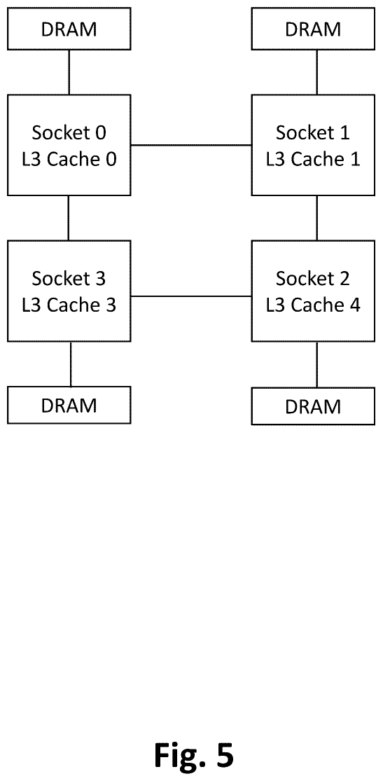

The current invention has separate modules for a) data ingestion; b) data quality checking; c) processing data after quality check. It would be appreciated by one of ordinary skill in the art that these separate modules could be separate code modules such as object oriented classes, or separate layers in a multi-tiered application. However, there is a performance advantage from implementing the current inventions modules either on separate cores as in FIG. 4, or on separate processors as in FIG. 5.

The current invention includes the ability to either assess currently available training data to determine if it is appropriate for machine learning training, and/or to go acquire additional data if needed. Systems like ChatGPT are given a specific set of training data, and can then learn from ongoing user input. However, the current invention both seeks out new data as needed, but also assesses the quality of that data before integrating the data into the machine learning training dataset. This has the effect of increasing the quality of data used for machine learning training and eliminating bias. Also, unlike other machine learning inventions, the current invention can constantly be learning, seeking out new information as it determines a need.

In one embodiment, the query module that is configurable to acquire new data, can be configured to also use web crawling and scraping. The basic process of web crawling is:
1. Begin with known “seed” URLs.
2. Fetch and parse them.
3. Extract URLs they point to
4. Place the extracted URLs in a queue.
5. Fetch each URL in the queue and repeat.

One aspect of the current invention is to assess the quality of proposed training data before adding it to the training dataset. The current invention uses one or more information theory pr statistical algorithms to assess the quality of incoming information/data.

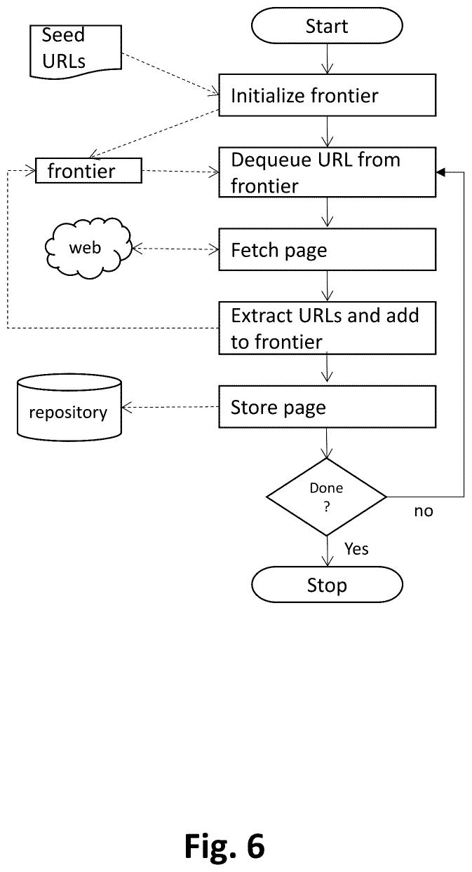

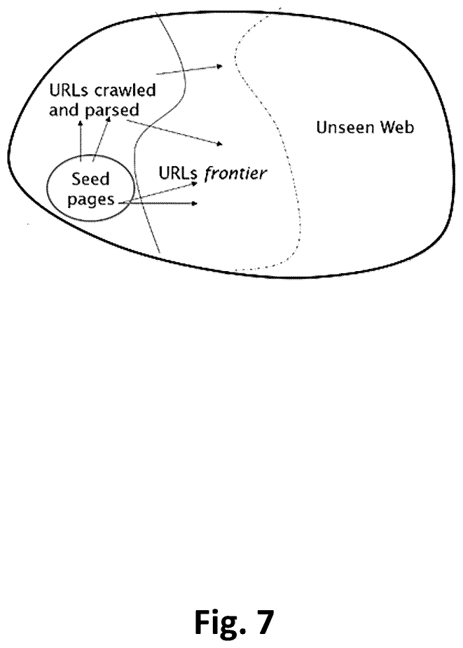

Another aspect of the current invention is to query new data when needed. This aspect of the invention is implemented in one of the following: software module, hardware processor, processor core, or separate hardware device. That query module is configurable to seek new data based on some metric being met, thus triggering data querying. The being sought could come from sources such as internet APis. One example of such an API for stock data is Polygon https://polygon.io. Another example of such an API for financial data is Morningstar https://www.morningstar.com. Another example of such an API for financial data is Finnhub https://finnhub.io/. One example of such an API for medical data is https://xcures.com/. Another example of such an API for medical data is HealthIT https://www.healthit.gov/data/api. An example of such an API for Geospatial data is https://www.reprisk.com/. An example of such an API for scientific data is NASA https://api.nasa.gov/. In addition to public API's, the query module could be coupled with a web scraping module that would perform web crawling, scraping data of websites. An exemplary web crawling process is shown in FIGS. 6 and 7.

Web scraping is a technique used to collect content and data from web pages on the internet. This technique is also sometimes referred to as data scraping. This data is usually saved in a local file or even to a database. The selection of what data to extract from a given web page is provided as parameters to the web scraping engine.

### Formulas/Algorithms Used:

The following section shows exemplary algorithms that can be used for assessing data quality. Depending on the embodiment, one or more of these could be used. The embodiment will also determine the data quality threshold for the data. The formula for calculating Shannon entropy is shown in equation 1.

$$H ( x ) = - {\sum }_{i = 1}^{n} {p}_{( xi ) {log}_{2} P ( xi )} \qquad ( eq . 1 )$$

In equation 1, H denotes the Shannon entropy over some variable x. The outcomes of x (Xi, . . . Xn) occur a probability denoted by Pxi, . . . . Pxn. While log base 2 is often assumed, it is expressly stated in equation 1 to avoid confusion. The information entropy provides a metric of information in a given message (Mishra & Ayyub, 2019).

Hartley entropy was introduced by Ralph Hartley in 1928 and is often referred to as the Hartley function. If a sample is randomly elected from a finite set A, the information revealed after the outcome is known is given by the Hartley function, shown in equation 2.

$${H}_{0} ( A ) := {log}_{b} \vert A \vert \qquad ( eq . 2 )$$

In the Hartley function the HO(A) is the measure of uncertainty inset A. The cardinality of A is denoted by |A|. If the base of the logarithm is 2, then the unit of uncertainty is referred to as the Shannon. However, if the natural logarithm is used instead, then the unit is the nat. When Hartley first published this function, he utilized a base-ten logarithm. Since that time, if a base 10 is used then the unit of information is called the Hartley. Hartley entropy tends to be a large estimate of entropy and is thus often referred to as max-entropy (Ribeiro, et al., 2021).

Another measure of information entropy is the Renyi entropy. The Renyi entropy is used to generalize four separate entropy formulas: Hartley entropy, the Shannon entropy, the collision entropy, and the min-entropy, as shown in equation 3.

$${H}_{a} ( x ) = \frac{1}{1 - α} log ( {\sum }_{i = 1}^{n} {p}_{i}^{α} ) \qquad ( eq . 3 )$$

In equation 16, X denotes discrete random variable with possible outcomes (1, 2, . . . , n) with probabilities Pi for i=1 to n. Unless otherwise stated, the logarithm is base 2, and the order, a is 0<a<1. The aforementioned collision entropy is simply the Renyi entropy in the special case that a=2, and not using logarithm base 2.

The diversity index is a quantitative metric for the different classes that are present in a dataset. There is not a single diversity index, but rather several different indices of diversity. Another term for diversity indices is the indices of phylogenetic metrics. That name is derived from the diversity index being applied to biological sets. In biological applications the classes within a particular dataset are phylogenetic classes such as species or genus.

There are different metrics that are utilized as specific diversity indices for particular applications. One such diversity metric is the Shannon-weaver index. This is sometimes referred to as the Shannon diversity index. The eponymously named Shannon diversity index was posited by Claude Shannon. Shannon used this metric to quantify the informational content in a given string of text. Shannon was most interested in electronic communications transmissions). When working with information theory, the information content of a message is referred to as the information entropy. The formula is shown in equation 4.

$${H}^{′} = - {\sum }_{n = 1}^{n} ( {p}_{i} * ln pi ) \qquad ( eq . 4 )$$

### Shannon-Weaver Index

In FIG. 4 Pi denotes the proportion of symbols which are part of the class of the ith class of symbol in the string. H′ symbolizes the Shannon Diversity Index. This metric is also referred to as the Shannon-Weaver diversity index.

Edward Simpson first formulated and published the Simpson index in 1948. This metric quantifies the concentration of individuals that are classified into groups. This concept has also been described eponymous name by diverse researchers who applied the metric to a range of disparate subject areas. The Simpson index is frequently applied in ecology. A similar metric is also used in microbiology. However, in microbiology this metric is referred to as the Hunter-Gaston index. The equation for the Simpson index is depicted in equation 5.

$$= {\sum }_{i = 1}^{R} {p}_{i}^{2} . \qquad ( eq . 5 )$$

### Simpson Index

In Equation 5 R is the sum of the different classes that are present in the dataset. Some researchers refer to the number of categories in a dataset as the richness of the dataset. Similar to the Shannon index, Pi represents the proportion of S composed of the i^{th} species.

Alpha Diversity is yet another diversity index. It is often used in biology to quantify the mean species diversity in a given habitat. There are actually three diversity metrics that are related to the alpha diversity metric. The alpha diversity is a metric of the diversity in local region. Beta diversity is a metric measuring diversity among habitats. Finally, gamma diversity is a metric describing a regions diversity. There have been a variety of formulations of these indices, one is shown in equation 6.

$${q}_{D α} = \frac{1}{{}^{q - 1} \sqrt{{\sum }_{j = 1}^{N} {\sum }_{i = 1}^{5} {P}_{iJ} {p}_{i}^{q} i \vert j}} \qquad ( eq . 6 )$$

### Alpha Diversity Index

In equation 6, N is the total number of individual subunits in the set. S represents the sum of different species in the dataset. Another term for S is the species richness. The proportion of the ith species in the jth subunit is Pili. In equation 6, the denominator is the arithmetic mean of the proportion of the various species within the subunits. These measures of diversity are key indicators of the complexity of the system in question.

In addition to information theory algorithms, standard statistics could be utilized to evaluate data quality. A sample of possible statistical algorithms is discussed in this section.

Kolmogorov-Smimov test. This is a nonparametric test of the equality of continuous data. Sometimes called a K-S test or just KS test. It can be a one sample to two sample test. This test quantifies the distance between the distribution function of the sample and a reference distribution function. The empirical distribution function F for n ordered observations X is defined as shown in equation 7.

$${F}_{n} ( x ) = \frac{1}{n} {\sum }_{i = 1}^{n} {I}_{[ - ∞ , x ]} ( {X}_{i} ) \qquad ( eq . 7 )$$

The Kruskal-Wallis test is a non-parametric test that compares two or more independent samples. The Kruskal-Wallis test is essentially a non-parametric version of the ANOVA test. Unlike the ANOVA, the Kruskal-Wallis test does not assume normal distribution of the data set. This test is often used to test correlations between two or more data sets that may not even have the same number of elements. The formula for the Kruskal-Wallis test is given in equation 8.

$$H = ( N - 1 ) \frac{{\sum }_{i = 1}^{g} {{n}_{i} ( {\overline{r}}_{i} - r )}^{2}}{{\sum }_{i = 1}^{g} {\sum }_{j = 1}^{{n}_{i}} {( {r}_{ij} - \overline{r} )}^{2}} \qquad ( eq . 8 )$$

1. A system comprising:
a computer having a processor device, an operating system, and storage devices comprising a computer memory and a persistent storage;
a separate module for data querying; said module being configurable to seek new data when a threshold is met; said threshold being data quantity, diversity, quality, or similar metric;
a separate module for data evaluation; said module being configurable to evaluate data based on information theory equations, statistical analysis, or similar data quality algorithm; and
a separate module configurable for machine learning execution; said module being capable of executing one or more machine learning algorithms using the data that has been acquired and tested for quality.

2. The system of claim 1 wherein the separate modules for data querying; data evaluation; and machine learning execution constitute software modules such as separate code modules, classes, or software components that are configurable for data querying, data evaluation, and machine learning.

3. The system of claim 1 wherein the separate modules for data querying; data evaluation; and machine learning execution constitute hardware modules such as separate processors, processor cores, or separate computers that are configurable for data querying, data evaluation, and machine learning.

4. The system of claim 1 further having a system for triggering data querying; said trigger can be configured to seek additional data based on or more of the following:
machine learning metrics such as algorithm accuracy;
information theoretic methods such as information diversity;
information theoretic methods such as information entropy; and
quantity of information; time since last information queried.

5. The system of claim 1 wherein triggering will cause the system to utilize the data querying module to seek out new data; that data is then processed and formatted, then ingested for use by the data evaluation modules.

6. The system of claim 1 where at least one of the data quality algorithms is the Shannon Entropy:
$$H ( x ) = - {\sum }_{i = 1}^{n} {p}_{( xi ) {log}_{2} P ( xi )} .$$

7. The system of claim 1 where at least one of the data quality algorithms is the Hartley Entropy:
$${H}_{0} ( A ) := {log}_{b} \vert A \vert .$$

8. The system of claim 1 where at least one of the data quality algorithms is the Rényi entropy;
$${H}_{α} ( x ) = \frac{1}{1 - α} log ( {Σ}_{i = 1}^{n} {p}_{i}^{α} ) .$$

9. The system of claim 1 where at least one of the data quality algorithms is the diversity index;
$${q}_{D α} = \frac{1}{\sqrt[q - 1]{{Σ}_{j = 1}^{N} {Σ}_{i = 1}^{S} 〚 {P}_{i J} {p}_{i}^{q} i \vert j 〛}} .$$

10. The system of claim 1 where at least one of the data quality algorithms is the Shannon Weaver index;
$${H}^{′} = - {Σ}_{n = 1}^{n} ( {p}_{i} * ln pi ) .$$

11. The system of claim 1 where at least one of the data quality algorithms is the Simpson index;
$$λ = {Σ}_{i = 1}^{R} {p}_{i}^{2} .$$

12. The system of claim 1 where at least one of the data quality algorithms is the Kolmogorov-Smirnov test;
$${F}_{n} ( x ) = \frac{1}{n} {Σ}_{i = 1}^{n} {I}_{[ - ∞ , x ]} ( {X}_{i} ) .$$

13. The system of claim 1 where at least one of the data quality algorithms is the Kruskal-Wallis test;
$$H = \frac{( N - 1 ) ( {Σ}_{i = 1}^{g} {{n}_{i} ( {\overline{r}}_{i .} - r \overline{} )}^{2} )}{{Σ}_{i = 1}^{g} {Σ}_{j = 1}^{{n}_{i}} ( {r}_{ij} - r \overline{} )} .$$

14. The system of claim 1 where the data query module utilizes web crawling and web scraping.

15. A system comprising: a computer having a processor device, an operating system, and storage devices comprising a computer memory and a persistent storage; a separate module for data querying; said module being configurable to seek new data when a threshold is met; said threshold being data quantity, diversity, quality, or similar metric; said data querying module also being configurable for object character recognition (OCR), a separate module for data evaluation; said module being configurable to evaluate data based on information theory equations, statistical analysis, or similar data quality algorithm; a separate module configurable for machine learning execution; said module being capable of executing one or more machine learning algorithms using the data that has been acquired and tested for quality.

16. The system of claim 15 wherein the separate modules for data querying; object character recognition (OCR); data evaluation; and machine learning execution constitute software modules such as separate code modules, classes, or software components that are configurable for data querying, data evaluation, and machine learning.

17. The system of claim 15 wherein the separate modules for data querying; object character recognition (OCR); data evaluation; and machine learning execution constitute hardware modules such as separate processors, processor cores, or separate computers that are configurable for data querying, data evaluation, and machine learning.

18. The system of claim 15 further having a system for triggering data querying; said trigger can be configured to seek additional data based on or more of the following: machine learning metrics such as algorithm accuracy; information theoretic methods such as information diversity; information theoretic methods such as information entropy; quantity of information; time since last information queried.

19. The system of claim 15 wherein triggering will cause the system to utilize the data querying module to seek out new data; that data is then processed and formatted, then ingested for use by the data evaluation modules.

20. The system of claim 15 where at least one of the data quality algorithms is the Shannon Entropy;
$$H ( x ) = - {\sum }_{i = 1}^{n} {p}_{( xi ) {log}_{2} P ( x i )} .$$

21. The system of claim 15 where at least one of the data quality algorithms is the Hartley Entropy;
$${H}_{0} ( A ) := {log}_{b} \vert A \vert .$$

22. The system of claim 15 where at least one of the data quality algorithms is the Rényi entropy;
$${H}_{α} ( x ) = \frac{1}{1 - α} log ( {Σ}_{i = 1}^{n} {p}_{i}^{α} ) .$$

23. The system of claim 15 where at least one of the data quality algorithms is the diversity index;
$${q}_{D α} = \frac{1}{\sqrt[q - 1]{{Σ}_{j = 1}^{N} {Σ}_{i = 1}^{S} 〚 {P}_{i J} {p}_{i}^{q} i \vert j 〛}} .$$

24. The system of claim 15 where at least one of the data quality algorithms is the Shannon Weaver index;
$${H}^{′} = - {Σ}_{n = 1}^{n} ( {p}_{i} * ln pi ) .$$

25. The system of claim 15 where at least one of the data quality algorithms is the Simpson index;
$$λ = {Σ}_{i = 1}^{R} {p}_{i}^{2} .$$

26. The system of claim 15 where at least one of the data quality algorithms is the Kolmogorov-Smirnov test;
$${F}_{n} ( x ) = \frac{1}{n} {Σ}_{i = 1}^{n} {I}_{[ - ∞ , x ]} ( {X}_{i} ) .$$

27. The system of claim 15 where at least one of the data quality algorithms is the Kruskal-Wallis test;
$$H = \frac{( N - 1 ) ( {Σ}_{i = 1}^{g} {{n}_{i} ( {\overline{r}}_{i .} - r \overline{} )}^{2} )}{{Σ}_{i = 1}^{g} {Σ}_{j = 1}^{{n}_{i}} ( {r}_{ij} - r \overline{} )} .$$

28. The system of claim 15 where the data query module utilizes web crawling and web scraping.
